(19) United States
(12) Patent Application Publication
(10) Pub. No.: US 2010/0086817 A1
(43) Pub. Date: Apr. 8, 2010

(54) WATER RETENTION AND GAS INGESTION CONTROL FOR A FUEL CELL

(76) Inventors: Tommy Skiba, East Hartford, CT (US); Ryan J. Balliet, Oakland, CA (US)

Correspondence Address: CARLSON, GASKEY & OLDS, P.C., 400 WEST MAPLE ROAD, SUITE 350, BIRMINGHAM, MI, 48009, US

(21) Appl. No.: 12/517,291

(22) PCT Filed: Dec. 29, 2006
(86) PCT No.: PCT/US06/49645

§ 371 Date: Jun. 2, 2009

(51) Int. Cl. H01M 8/04; H01M 2/02

(52) U.S. Cl. 429/26; 429/34

(57) ABSTRACT

A fuel cell includes a water transport plate providing a water flow field. The water flow field includes water having gas. A vent is in fluid communication with the water flow field. The vent includes a membrane that obstructs flow of water past the membrane while permitting the flow of gas past the membrane. The membrane can include a pore size between approximately 0.1μ to 10.0μ, which enables gases to pass through the pores while blocking water. The membrane can be hydrophobic, for example, Teflon, to prevent the passage of water through the membrane. A hydrophobic fluid can also be arranged on the membrane to act as a check valve.

### BACKGROUND OF THE INVENTION

This invention relates to managing gases within the fuel cell, which need to be released to the atmosphere while retaining the water within the fuel cell.

A hydrogen fuel cell uses a cathode and anode that receive an oxidant such as air and a fuel such as hydrogen, respectively, and generate an electrochemical reaction that produces electricity, as is well known. The reactant gases are fed to the membrane electrode assembly via reactant flow fields. The fuel cell typically includes numerous cells that form a stack. A means to cool the fuel cell is also provided, typically coolant flow fields interspersed among the cells forming the stack. The coolant may be water in some fuel cell systems. The cells typically include separator plates to prevent reactant gases from commingling. The separator plates may be solid or porous. Porous separator plates, referred to as water transport plates, permit through-plane movement of water but have a pore size and structure so as to restrict through-plane gas transfer. The through-plane movement of water permits membrane hydration and enables removal of product water on the cathode side, which is generated from the electrochemical reaction.

The volume of water within the stack must be managed to maintain a desired amount of water, for example, for membrane hydration and cooling. In one type of cooling system, water is evaporated and then condensed to return liquid water to the fuel cell. Evaporatively cooled fuel cells have far less water than similar fuel cells using other types of cooling strategies. Gases may become entrained in the coolant flow field passages due to leakage from ambient surroundings, or reactant crossover through the seals or the pores of the water transport plates, on the order of one cubic centimeter per minute per cell in the stack in one example. Entrained gases inhibit the replenishment of liquid water to the coolant flow field, which can cause operational problems with the fuel cell. The gases must be expelled from the fuel cell to maintain desired operation of the fuel cell.

What is needed is a simple method and apparatus of releasing gases from the fuel cell without losing water.

### SUMMARY OF THE INVENTION

A fuel cell includes a water transport plate providing a water flow field. The water flow field includes water having gas. A vent is in fluid communication with the water flow field. The vent includes a membrane that obstructs flow of water past the membrane while permitting the flow of gas past the membrane. The membrane can include a pore size between approximately 0.1μ to 10.0μ, which enables gases to pass through the pores while blocking water. In one example, the membrane can be hydrophobic, for example, Teflon, to prevent the passage of water through the membrane. A fluid can also be arranged on the membrane to act as a check valve. In another example, the fluid is hydrophilic, attracting any water away from the membrane.

Accordingly, gases can be released from the fuel cell without undesirably reducing the volume of water within the fuel cell.

These and other features of the present invention can be best understood from the following specification and drawings, the following of which is a brief description.

### BRIEF DESCRIPTION OF THE DRAWINGS

FIG. 1 is schematic view of a fuel cell arrangement including an evaporative cooling loop.

FIG. 2 is a schematic view of a water flow field with a vent.

FIG. 3 is a schematic view of the vent shown in FIG. 2 with a membrane used for releasing gas and retaining water.

FIG. 4 is a schematic view of the vent shown in FIG. 3 with a fluid supported on the membrane.

### DETAILED DESCRIPTION OF THE PREFERRED EMBODIMENT

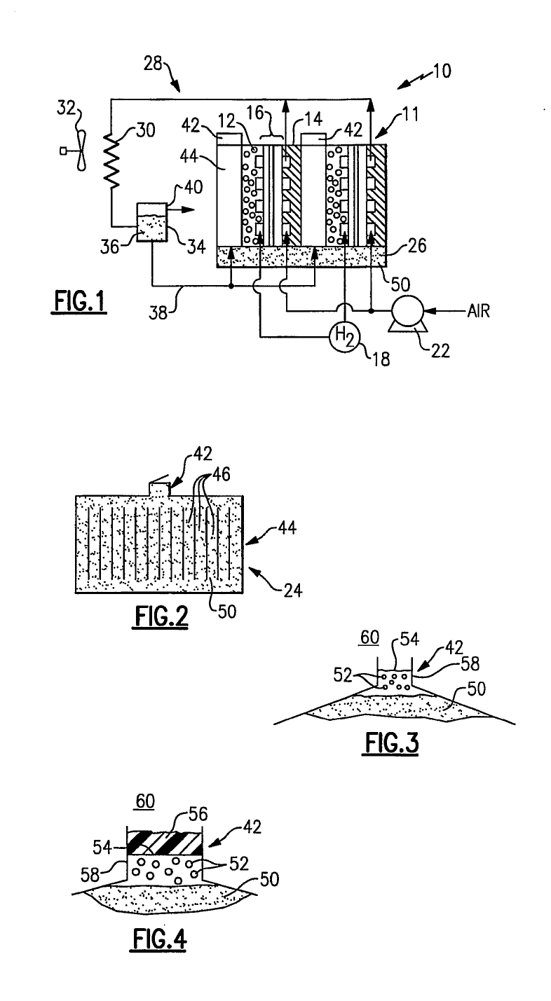

FIG. 1 schematically illustrates a fuel cell 10 that includes an anode 12 and a cathode 14. The anode 12 receives hydrogen from a fuel source 18. The cathode 14 receives air from a blower 22 that chemically reacts with the hydrogen in a membrane electrode assembly (MBA) 16 that is arranged between the cathode and anode 12, 14.

A water transport plate 44 provides a water flow field 24 (FIG. 2) that is in fluid communication with the anode and cathode 12, 14. The anode 12, cathode 14, MEA 16 and water transport plate 44 provide a cell 11. Multiple cells 11 are arranged in a cell stack assembly to provide a desired amount of power. In one example, at least a portion of the water transport plate 44 for at least one of the cathode or anode is porous. The water flow fields 24 are fluidly connected to one another by a water manifold 20 in one example, although they are depicted schematically separate in FIG. 1. Water 50 within the water flow field 24 hydrates the water transport plates and collects product water from the cathode 14 resulting from the electrochemical process. An accumulator 26 is also filled with water 50 to ensure that the fuel cell 10 has a desired volume of water for proper operation of the fuel cell.

A cooling loop 28 receives evaporated water from the cathode exhaust that is produced by the heat generated from the cells. The water vapor is condensed with a condenser 30 and fan 32, or similar arrangement. Liquid water 36 is collected in a separator 34 and gases are vented through an exit 40 in the separator 34. A return line 38 supplies the liquid water 36 back to the fuel cell 10.

Referring to FIG. 2, an example water transport plate 44 is shown having channels 46 that provide the water flow field 24. Gas bubbles migrate toward the vent 42 by buoyancy and the coolant flow. The gases accumulate during operation of the fuel cell 10 and must be released to the atmosphere. It is desirable to vent these gases without using complex valves and/or controls.

Referring to FIG. 3, a membrane 54 is arranged within a passage 58 of the vent 42. One side of the membrane 54 is exposed to atmosphere 60 in the example shown. The other side of the membrane 54 is exposed to the water flow field 24. The membrane 54 permits gases 52 to pass through it while preventing water vapor or liquid water from passing through the membrane 54. The pore size of the membrane 54 is a function of the pressure differential across it. In one example, the membrane 54 includes a pore size of between approximately 0.1μ to 10.0μ. In one example, the pore size is between approximately 0.1μ to 5.0μ. The pore size is sufficient to permit the gases 52 to escape while preventing the water 50 from passing through the membrane 54. The membrane 54 can be constructed from a hydrophobic material such as a fluorine-based polymer, for example, Teflon.

Referring to FIG. 4, a head of fluid 56 can be supported on the membrane 54 to prevent gases from the atmosphere 60 from migrating backwards through the membrane into the passage 58, thereby acting as a check valve, even in freezing conditions. In one example, the fluid is electrically polar to attract any water molecules that may form on surface of the membrane 54 that is exposed to the atmosphere 60. In another example, the fluid may be PEG-400 anti-freeze, which is polyethylene glycol-based and will not freeze in most automotive environments. PEG-400 has a low vapor pressure so that it does not have to be replenished often. The fluid 56 permits the gases 52 to pass through it while preventing water from building up and freezing on the membrane 54. However, gases from the atmosphere will not become ingested in the water 50.

Although a preferred embodiment of this invention has been disclosed, a worker of ordinary skill in this art would recognize that certain modifications would come within the scope of this invention. For that reason, the following claims should be studied to determine the true scope and content of this invention.

1. A fuel cell comprising:
a water transport plate providing a water flow field, the water flow field including water having gas; and
a vent in fluid communication with the water flow field, the vent including a membrane obstructing flow of the water past the membrane while permitting the flow of the gas past the membrane, wherein the membrane includes a fluorine-based polymer.

2. The fuel cell according to claim 1, comprising a cathode and anode, water from the water transport plate passing through at least one of the cathode and anode.

3. The fuel cell according to claim 2, comprising a cooling loop in fluid communication with the water flow field that receives water vapor, the cooling loop including a condenser for condensing the water vapor to liquid water, a separator for separating a the water vapor and liquid water, and a return line for supplying the liquid water to the water flow field.

4. The fuel cell according to claim 1, wherein the water flow field includes inclined walls guiding the gas to the vent.

5. The fuel cell according to claim 1, wherein the membrane is hydrophobic.

6. The fuel cell according to claim 1, wherein the fluorine-based polymer includes Teflon.

7. The fuel cell according to claim 1, comprising:
a membrane electrode assembly;
a first separator plate disposed on a first side of the membrane electrode assembly;
a second separator plate disposed on a second side of the membrane electrode assembly opposite the first side;
wherein at least one of the first separator plate and second separator plate has a porous section, wherein at least one of the first separator plate and second separator plate have a reactant flow field disposed thereon; and
a water flow field in fluid communication with the porous section of the at least one of the first separator plate and second separator plate.

8. A fuel cell comprising:
a water transport plate providing a water flow field, the water flow field including water having gas; and
a vent in fluid communication with the water flow field, the vent including a membrane obstructing flow of the water past the membrane while permitting the flow of the gas past the membrane, wherein the membrane has a pore size of between approximately 0.1μ to 10.0μ.

9. The fuel cell according to claim 8, wherein the membrane has a pore size of between approximately 0.1μ to 5.0μ.

10. The fuel cell according to claim 9, comprising a cathode and anode, water from the water transport plate passing through at least one of the cathode and anode.

11. The fuel cell according to claim 10, wherein the water flow field includes inclined walls guiding the gas to the vent.

12. The fuel cell according to claim 9, wherein the membrane is hydrophobic.

13. The fuel cell according to claim 9, comprising:
a membrane electrode assembly;
a first separator plate disposed on a first side of the membrane electrode assembly;
a second separator plate disposed on a second side of the membrane electrode assembly opposite the first side;
wherein at least one of the first separator plate and second separator plate has a porous section, wherein at least one of the first separator plate and second separator plate have a reactant flow field disposed thereon; and
a water flow field in fluid communication with the porous section of the at least one of the first separator plate and second separator plate.

14. A fuel cell comprising:
a water transport plate providing a water flow field, the water flow field including water having gas; and
a vent in fluid communication with the water flow field, the vent including a membrane obstructing flow of the water past the membrane while permitting the flow of the gas past the membrane, wherein the membrane separates a passage into first and second sides, the water arranged on the first side, and a hydrophobic liquid arranged on the second side.

15. The fuel cell according to claim 10, wherein the hydrophobic liquid is exposed to atmosphere.

16. The fuel cell according to claim 14, comprising a cathode and anode, water from the water transport plate passing through at least one of the cathode and anode.

17. The fuel cell according to claim 16, comprising a cooling loop in fluid communication with the water flow field that receives water vapor, the cooling loop including a condenser for condensing the water vapor to liquid water, a separator for separating a the water vapor and liquid water, and a return line for supplying the liquid water to the water flow field.

18. The fuel cell according to claim 14, wherein the water flow field includes inclined walls guiding the gas to the vent.

19. The fuel cell according to claim 14, wherein the membrane is hydrophobic.

20. The fuel cell according to claim 14, comprising:
a membrane electrode assembly;
a first separator plate disposed on a first side of the membrane electrode assembly;
a second separator plate disposed on a second side of the membrane electrode assembly opposite the first side;
wherein at least one of the first separator plate and second separator plate has a porous section, wherein at least one of the first separator plate and second separator plate have a reactant flow field disposed thereon; and
a water flow field in fluid communication with the porous section of the at least one of the first separator plate and second separator plate.
